(19) United States
(12) Patent Application Publication
(10) Pub. No.: US 2012/0074762 A1
(43) Pub. Date: Mar. 29, 2012

(54) MULTI-DIAMETER TIRE AND WHEEL ASSEMBLY FOR IMPROVED VEHICLE MILEAGE WITH PASSIVE TRANSFER BETWEEN TIRE DIAMETERS

(76) Inventor: Ken Pope, Napa, CA (US)

(21) Appl. No.: 12/890,874

(22) Filed: Sep. 27, 2010

(51) Int. Cl. B60B 11/00

(52) U.S. Cl. 301/36.1

(57) ABSTRACT

The invention is a replacement wheel/tire assembly for a vehicle where the new assembly maximizes the balance between travel efficiency or mileage of the vehicle and traction requirements of the vehicle tires for safety and/or high performance. The invention yields an efficient driving mode on large diameter tires and a performance driving mode on small diameter tires, with passive and automatic transfer between these modes. Multi-diameter tire and wheel assembly comprises: at least one large diameter tire, at least one large diameter wheel, at least one small diameter tire, at least one small diameter wheel, and a wheel connection means. The number of wheels is equal to the number of tires in each multi-diameter tire and wheel assembly. Each large diameter tire is mounted and inflated onto one large diameter wheel and each small diameter tire is mounted and inflated onto one said small diameter wheel. Wheels are connected together in adjacent concentric fashion so that the centers of each said wheel and each said tire are aligned on the central longitudinal axis running down the center of said multi-diameter tire and wheel assembly. Multi-diameter tire and wheel assembly may be attached to a vehicle hub using existing studs located on the vehicle hub and existing lug nuts.

### BACKGROUND OF THE INVENTION

1. Field of the Invention

The present invention relates to a pneumatic or gas-filled tire and wheel assembly for attachment to a hub of a motor vehicle, where each tire and wheel assembly comprises at least one small diameter tire and at least one large diameter tire. Transfer occurs as necessary back and forth between large and small diameter tires to meet all driving conditions with the most efficient tire design while also providing adequate tire traction for safety. Large diameter tires are used for efficient driving mode, while the small diameter tires are used for performance driving mode. Transfer occurs passively, without electronic, computer, or human-controlled mechanisms, and is seamless to the driver by way of a constant tire pressure process with relatively constant tire inflation pressure during the transfers. The invention optimizes a blend of large and small diameter design characteristics to yield a safe tire assembly design with maximum fuel efficiency or mileage of the vehicle without any decrease in safety or tire traction.

2. Description of Related Art

A high profile or narrow taller tire may be defined as a tire having a comparatively high aspect ratio, or height-to-width ratio, where the height is the distance measured radially from the tire's outer diameter to the rim opening or rim seat. A narrow, taller tire with a comparatively smooth tread design is preferred where fuel economy, low road noise, and ride quality are the main operational concerns. However, taller tires do not have ideal handling characteristics in terms of steering, acceleration, and braking in aggressive driving conditions such as rainy conditions, sudden obstacles, or other condition where a large degree of safety or performance margin is required to avoid a collision or other hazard. A wider tire, with a coarser tread design, and perhaps a softer rubber formulation for improved traction, may be preferred for vehicles intended for high-performance handling and under aggressive driving conditions. However, wider tires do not perform as well as taller tires in terms of fuel economy, road noise, ride quality, and tire wear. Additionally, more inflation pressure of a tire typically improves tire efficiency but has adverse effects on performance. Thus, efficiency design factors and performance design factors by in large are in conflict with each other.

Tire selection typically involves compromise, sacrificing certain desirable performance characteristics for others. Vehicles such as family sedans or mini-vans, which are mainly intended for comparatively sedate driving styles and straight-line highway driving, are typically fitted with softer riding taller tires. These taller tires give them better gas mileage. Sports sedans and sports cars are commonly fitted with wider high-performance tires. Each of these compromises is acceptable when the vehicles in question are being operated according to their primary intended functions, but both suffer from significant drawbacks when operational conditions change. A vehicle riding on taller tires requires slower speeds to navigate narrow, winding roads where tight cornering and hard braking may be required, especially when traction is poor due to rough, wet, or icy road surface conditions. In contrast, a vehicle with wider, high-performance tires generally handles much more responsively under such adverse conditions than if it had taller narrower tires, but on the freeways it will give a rougher and noisier ride, with poorer fuel economy.

Prior art discloses numerous attempts to provide vehicle tire systems that use multiple-tire assemblies to adapt to different operating conditions. U.S. Pat. No. 6,637,834 issued to Elkow on Oct. 15, 2001, discloses a variable diameter wheel apparatus that uses a pump to inflate or deflate each tire independently to achieve optimum performance from a multiple tire arrangement. Sensors monitor selected operational parameters of the vehicle and transmits corresponding signals to a computer that selects an optimal tire configuration.

U.S. Pat. No. 2,751,959, issued to Blomquist on Jun. 26, 1956, discloses a tire-and-wheel assembly having a selectively-inflatable auxiliary tire coaxially on a specialized telescoping rim and axle assembly, disposed between two conventional tires. The auxiliary tire has an accordion-like construction. The diameter of the auxiliary tire when uninflated is less than that of the two conventional tires, so the auxiliary tire is not in contact with the road surface when it is uninflated. When inflated, its diameter expands to match that of the conventional tires, and it also expands laterally, displacing the outboard conventional tire further outboard. Accordingly, inflation of the auxiliary tire greatly increases the total width of the wheel assembly and the total area of tire contact with the road surface, thereby providing improved traction.

In U.S. Pat. No. 5,788,335, issued to O'Brien on Aug. 4, 1998, and in related U.S. Pat. No. 6,022,082, issued to O'Brien on Feb. 8, 2000, a studded, selectively inflatable auxiliary tire of specialized construction is coaxially disposed between two conventional tires. As in Blomquist, the uninflated diameter of the auxiliary tire in the O'Brien patents is less than that of the conventional tires. Upon inflation, the auxiliary tire expands in diameter, but does not expand laterally as in Blomquist, until it substantially matches the diameter of the conventional tires, such that the studs of the auxiliary tire may engage the road surface. The auxiliary tire thus may be inflated or deflated as desired, to suit particular road conditions. The auxiliary tire of U.S. Pat. No. 5,788,335 is expressly not intended to carry any of the vehicle weight, whereas U.S. Pat. No. 6,022,082 contemplates that all three tires may be load carrying. However, the two conventional tires carry vehicle loads at all times. The inventions disclosed in the O'Brien patents cited above are directed primarily to providing enhanced traction on slippery road surfaces, with the means for providing enhanced traction being disengageable when road conditions are favorable.

Other prior art references are: U.S. Pat. No. 2,201,632, issued May 21, 1940 (Roessel); U.S. Pat. No. 2,241,849, issued May 13, 1941 (Fuchs); U.S. Pat. No. 2,254,318, issued Sep. 2, 1941 (Roessel); U.S. Pat. No. 2,765,199, issued Oct. 2, 1956 (Partin); U.S. Pat. No. 5,810,451, issued Sep. 22, 1998 (O'Brien); U.S. Pat. No. 5,839,795, issued Nov. 24, 1998 (Matsuda et al.); and U.S. Pat. No. 6,044,883, issued Apr. 4, 2000 (Noyes).

Prior art discloses technology for increased traction and skid resistance on wet or icy roads while also addressing other objectives such as ride quality, fuel economy, or general handling characteristics. However, these attempts were different because they did not provide a safe tire assembly capable of travelling at highway speeds while delivering maximum fuel efficiency using tire assemblies with large and small diameter tires and a method of transfer between such using constant tire pressure process with constant tire pressure.

Prior art discloses uninflated or underinflated wheels that can be hazardous, can come loose from the rim, and get caught under one of the other functioning tires, creating a rollover situation. The designs add unnecessary weight, which decreases fuel efficiency, decreases braking ability, and could cause a rollover. If a pump fails, all four of the tires could be flattened, creating a crash prone scenario. If the computer, actuator, communication link, or any one of many sensors malfunctions, a life threatening condition arises. The central tire could expand as the vehicle goes around a sharp curve, removing all traction from the tires. The prior art involves complex traction mechanisms or tires of specialized construction with special sensors, computers, and pump configurations. Most prior art involves one or more conventional tires which are in load-bearing contact with the road surface at all times, regardless of whether the invention's particular traction enhancement or performance means are engaged, and regardless of the road conditions being travelled on.

None of the prior art provides a wheel/tire assembly that in itself provides a passive system that seamlessly transfers between large and small diameter tires at the precise instances or conditions required to yield a maximized balance between vehicle performance and efficiency. This invention is first to yield substantially improved vehicle efficiency or mileage without decreasing safety in a passive and seamless manner to the driver. Special care was taken in the design of the invention to yield this passive non-mechanical seamless transfer system with maximized efficiency.

### BRIEF SUMMARY OF THE INVENTION

The present invention is a wheel-and-tire apparatus or assembly for mounting on a motor vehicle hub as a replacement of a conventional single-tire wheel/tire assembly. The invention includes an assembly of two or more coaxially mounted tires of different diameters. The larger diameter tires will always be in contact with the road surface over which the vehicle is travelling. At slow speeds or straight driving when rolling resistance is a large factor in determining vehicle mileage, the large diameter tires will be the only tires in contact with the road surface. At higher speeds, during braking, accelerating, turning, or other maneuverings, the smaller diameter tires will contact the road surface due to an increased force on the apparatus in one or more directions, yielding more surface area for the vehicle to ride on, allowing the vehicle to handle much more responsively. When the increased force is removed, or during slow, straight, or other driving with relatively minor changes in momentum of the vehicle, the apparatus resumes riding on the larger diameter tires. Large diameter driving is the default condition. Larger diameter driving occurs at the optimal or maximum amount of driving time without detracting from safety. When driving conditions require higher performance, a threshold is reached, and the apparatus passively and seamlessly transfers to smaller diameter tires, only to quickly passively and seamlessly return to larger diameter tires as soon as is safe where driving conditions no longer demand higher traction. The threshold point is specifically designed into the invention and primarily depends on the weight of the vehicle, along with other factors. Different tire assemblies will be required for different vehicles with different weights or different traction requirements. Tires are constructed of tough but resilient material such as composite vulcanized elastomeric material with added fabric or material layers for strength. Tires may be constructed of standard material already known in the art of tires. Wheels are cylindrical and constructed of rigid material already known in the art of wheels.

### BRIEF DESCRIPTION OF THE DRAWINGS

FIG. 1A is a cut-away view of the invention connected to a vehicle with negative camber angle 2 that is experiencing force 3 in the general downward direction.

FIG. 1B is a cut-away view of the invention connected to a vehicle with zero camber angle.

FIG. 2A is a geometric depiction of the invention in efficiency mode and in performance mode where critical design dimensions responsible for the passive seamless transfer are called out.

FIG. 2B is a depiction of the length 7E and width 8 of the large diameter tire footprint on the road surface while in efficiency mode.

FIG. 2C is a depiction of the length 7P and width 8 of the large diameter tire footprint and width 9 of small diameter tire on the road surface while in performance mode.

FIG. 3 is a cross-sectional view of the invention in three-wheel/tire mode.

FIG. 4 is a side elevation view of the invention in three-wheel/tire mode.

FIG. 5 is a front elevation view of the invention in three-wheel/tire mode.

FIG. 6 is an exploded cross-sectional view of the invention in three-wheel/tire mode.

FIG. 7 is an exploded perspective view of the invention in three-wheel/tire mode.

### DEFINITION LIST

| Term | Definition |
|---|---|
| 1 | Axis perpendicular to the road surface |
| 2 | Camber angle of vehicle hub |
| 3 | Vehicle force or effective weight of the vehicle |
| 4 | Difference between radius of large diameter tire and that |
| | small diameter tire (H-Factor) |
| 5 | Radius of small diameter tire (A) |
| 6 | Radius of large diameter tire (R) |
| 6A | Half of the length of the footprint of the large diameter tire |
| | while in performance mode (B) |
| 7E | Length of the footprint of the large diameter tire while in |
| | efficiency mode |
| 7P | Length of the footprint of the large diameter tire while in |
| | performance mode (L) |
| 8 | Width of the footprint of the large diameter tire (W) |
| 9 | Width of the footprint of the small diameter tire while in |
| | performance mode. |
| 10 | Multi-diameter tire and wheel assembly in three-wheel/tire |
| | mode. |
| 11 | Wheel for large diameter tire |
| 12 | Wheel for small diameter tire |
| 13 | Small diameter tire |
| 14 | Large diameter tire |
| 15 | Alternate additional small diameter tire |
| 16 | Alternate additional wheel for alternate additional small |
| | diameter tire |
| 17 | Large diameter wheel/tire assembly to small diameter |
| | wheel/tire assembly connection means depicting mode using |
| | lug nuts |
| 18 | Large diameter wheel/tire assembly to small diameter |
| | wheel/tire assembly connection means depicting mode using |
| | threaded studs |
| 19 | Multi-diameter tire and wheel assembly to vehicle hub |
| | connection means depicting mode using lug nuts and |
| | threaded studs |
| 40 | Road surface |

### DETAILED DESCRIPTION OF THE INVENTION

Multi-diameter tire and wheel assembly comprises: at least one large diameter tire mounted on at least one large diameter wheel connected to at least one small diameter tire mounted on at least one small diameter wheel. Large diameter wheels are capable of receiving for mount one large diameter tire. Small diameter wheels are capable of receiving for mount one small diameter tire. Each assembly includes appropriate seals between wheel and tire members to contain pressurized air or other gas within the interior of the wheel/tire assembly. The number of wheels and tires used in the invention is the same. For instance, if one large diameter wheel/tire assembly and one small diameter wheel/tire assembly is used per wheel hub for a vehicle with four hubs, as is a typical application of the invention on a typical motor vehicle, the invention would include four wheel/tire assemblies, each assembly comprising one large diameter wheel/tire sub-assembly connected to one small diameter wheel/tire sub-assembly. Multi-diameter tire and wheel assembly may be mounted to a vehicle hub by any means. It is preferred that multi-diameter tire and wheel assembly be mounted to an existing vehicle hub by standard means i.e. existing threaded studs permanently attached to the vehicle hub where wheel/tire assembly is sandwiched between said studs and a lug nut securely tightened onto each stud. Thus, in best mode, multi-diameter tire and wheel assembly must have a slender enough profile to permit exposure of the threaded studs on the other side of the multi-diameter tire and wheel assembly thereby allowing attachment by existing lug nuts or standard attachment means.

Before being mounted on the vehicle hub, at least one large diameter wheel/tire assembly and at least one small diameter wheel/tire assembly are mounted together or connected in an adjacent fashion. Wheel/tire assemblies are mounted “coaxially” so that the centers of each wheel and tire are equivalent or aligned and each wheel and tire is concentric around the longitudinal axis of the axle attached to the hub. Thus, each tire/wheel assembly rotates around the axle when properly attached to the vehicle hub. In two-wheel per hub mode, at least one small diameter wheel/tire may either be mounted on the “inside” or “outside” of the large wheel/tire assembly as mounted on the vehicle. The same orientation, small diameter on outside or inside, must typically be used on all hubs of the vehicle. Large and small diameter wheels may be connected by connectors or any connection means or fastening means. Fastening means may be with bolts, screws, clamps, rivets, welds, or other similar means. Alternately, large and small diameter wheels may be manufactured as one unit such as a single molded, poured, cast, or machined multi-wheel. In all cases, each tire has its own air chamber and pair of bead seals or other appropriate seals between wheel and tire members required to contain gas in the tire chamber under high pressure. Ideally, the design is modular where wheels are separate components and the wheel fastening means is reversible so that wheels may be easily connected together and easily disconnected. A modular design of the invention allows for easy and efficient maintenance from wear, weather, or hazard allowing the replacement of perhaps only one tire or wheel of the whole assembly without requiring replacement of any other component, and allowing such to be accomplished at a regular tire shop, vehicle repair shop, or home garage.

Large diameter wheels must not have an outer diameter larger than that of small diameter tires. This is because large diameter tires must be able to flex and change their effective diameters thereby allowing the vehicle to move upwards and downwards between contact and no contact of the small diameter tire contact with the road surface without large diameter wheels “bottoming out” or contacting the road surface through the relatively thin layer of the tire. Instead, the structure of small diameter tires must receive and support the weight of the vehicle.

A very important criterion of the invention is the threshold “force” or “effective vehicle weight change” required to “push” the vehicle downward, rearward, forward or laterally in order to bring the small diameter tires to come in contact with the road surface. This is important because this action marks the transition between fuel-efficient low-performance large diameter efficiency mode and fuel-inefficient high-performance small diameter performance mode. This transition must be designed or engineered to occur precisely at a proper threshold or level in order to balance safety requirements with efficiency requirements in order to yield safe and efficient travel. E.g., drivers would not want to be in high-efficiency low-performance mode when high-performance is necessary such as during braking or turning or similar because an accident or unsafe condition could result. Likewise, drivers would not want to be in high-performance mode during straight highway driving or similar because this would unnecessarily raise fuel or energy costs of the travel thereby reducing efficiency or mileage of the vehicle.

In order for the passive transfer aspect to perform properly with ample safety or tire traction, special care must be taken in the shape and design of the tires and wheels. Large diameter tires must be specially shaped to yield the appropriate efficiency characteristics while also yielding the appropriate transition characteristics. Transition occurs when the radius or outside diameter of the large diameter tire decreases to at least that of the small diameter tires. This occurs because of an increase in force or effective weight of the vehicle in a direction downward, downward-forward, downward-rearward, or downward-lateral causing an increased force on the large diameter tires in one or more of these directions.

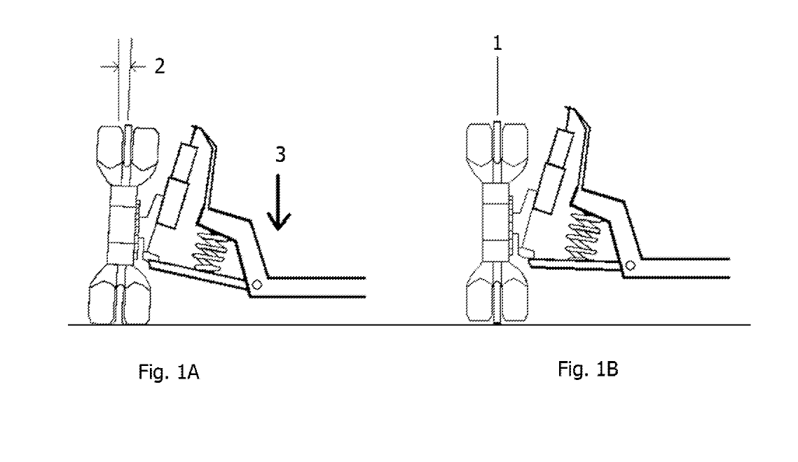

Alternately transition could occur even at low speed by turning the vehicle, i.e. turning the steering wheel of the vehicle, resulting in a camber angle change. Camber is the angle between the vertical axis of the tire and the vertical axis of the vehicle when viewed from the front or rear. See FIGS. 1A and 1B. Camber angle is primarily used in the design of steering and suspension. As a result of a non-zero camber angle, when the wheel/tire assemblies are turned, i.e. when the vehicle steering wheel is turned, the angle can cause the small diameter tire to come in contact with the road surface. The more camber angle, the more this occurs.

Pressure remains constant in each tire chamber, as is the case with standard single-tire assemblies. In this way, no air pumping, inflating, deflating, heating, cooling, or any mechanical action whatsoever is required for the transition. Additionally, no additional time is required to pump, inflate, deflate, heat, cool, or cycle an action in order for the transition to take place.

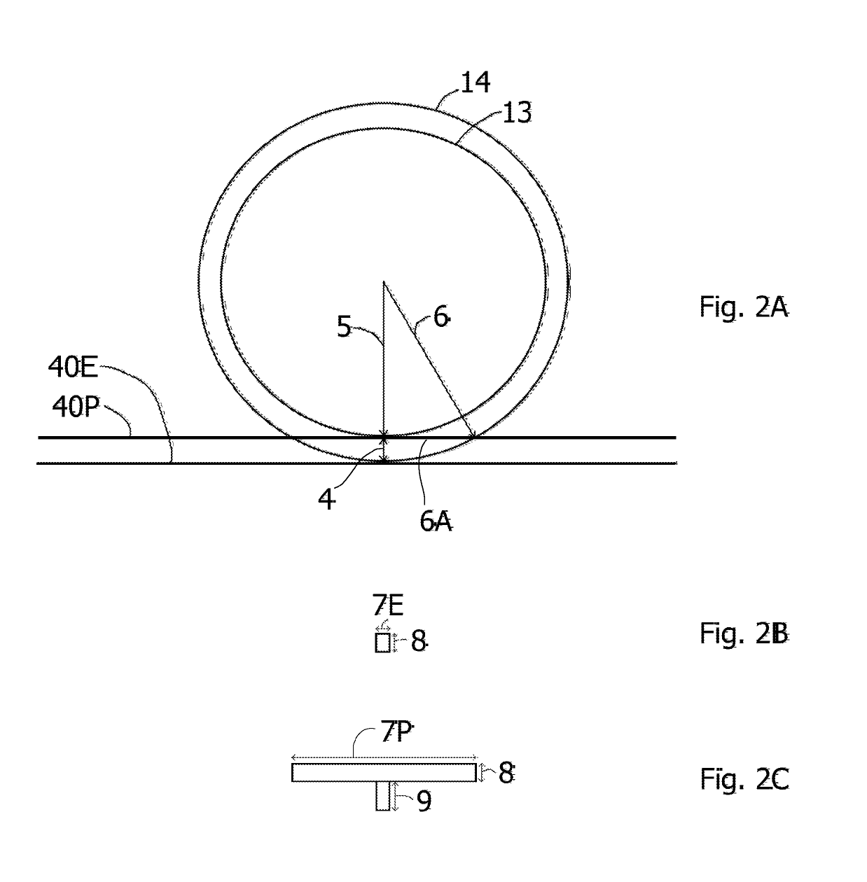

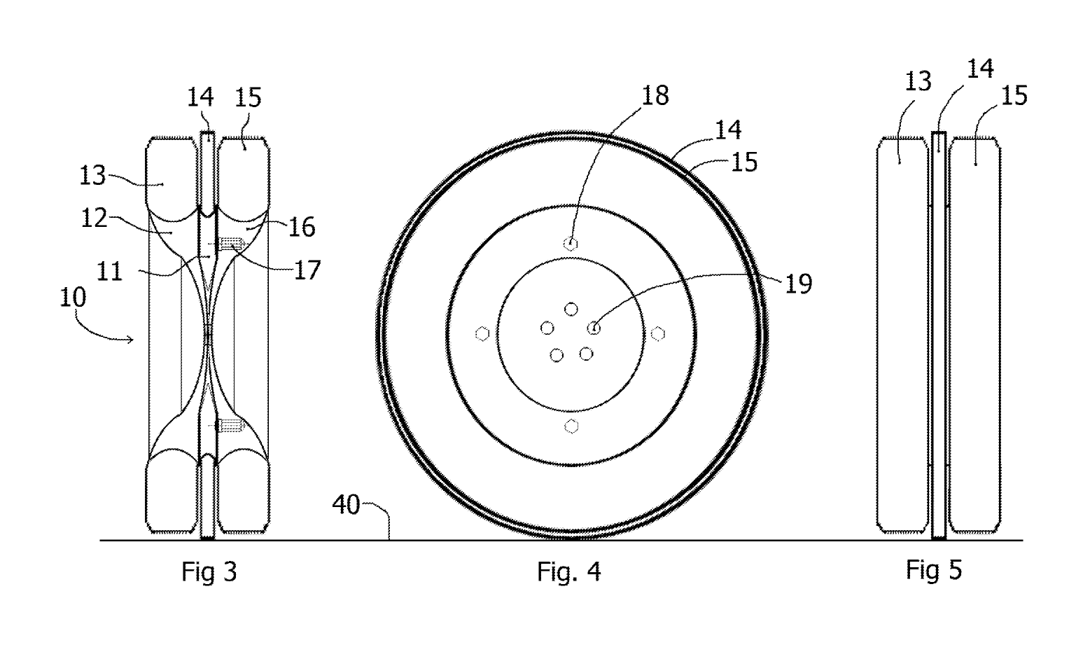

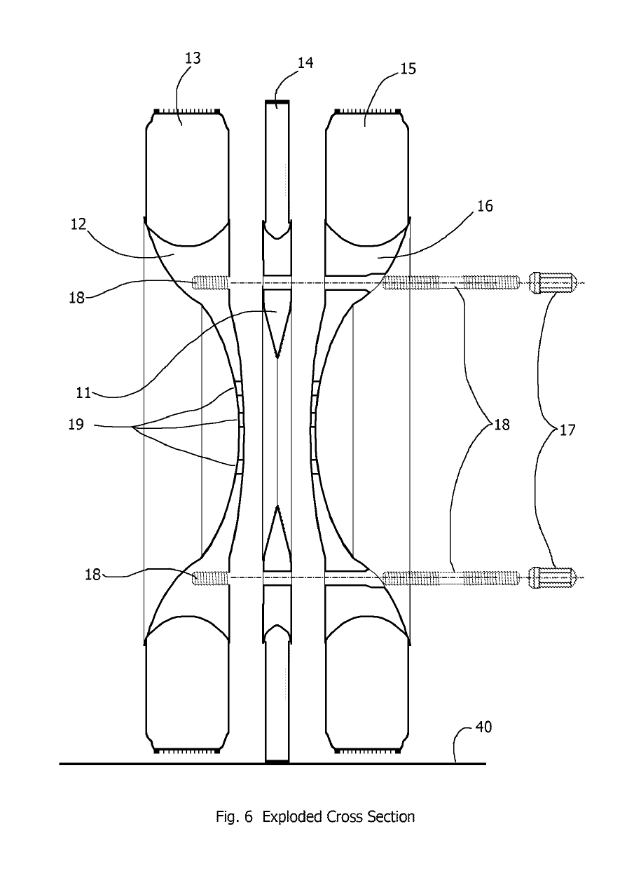

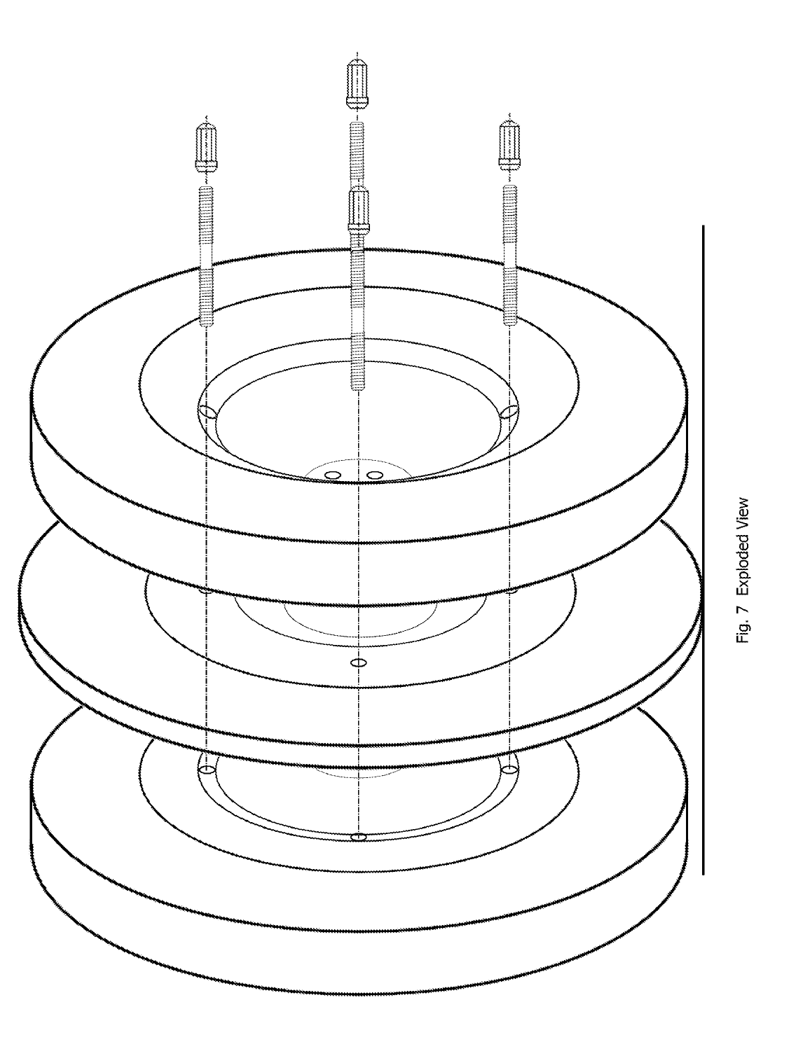

As stated, tall thin tires yield better efficiency, and thus we use such design for large diameter tires yielding a tire with a narrow width footprint on the road surface. When the increased force occurs, the length of this footprint increases. See FIGS. 2A, 2B, and 2C. 7E denotes the length of large diameter tire footprint in efficiency mode and 7P denotes the length of large diameter tire footprint in performance mode. Item 8 denotes the width of large diameter tire footprint and 9 denotes the width of the small diameter tire footprint in performance mode. Note that with a tall narrow profile tire, the width footprint does not typically increase in reaction to the increased force. Large diameter tire must have a high enough profile or be tall enough, in relation to small diameter tire, to allow the large diameter tire shape to deform as shown in FIGS. 2A, B, and C to allow small diameter tires to contact the road surface while maintaining the seal in the tire and without popping, losing air, or deflating in some way. Large diameter tire must also be made of the appropriate resilient, flexible material to allow such deformation where such material must also be very tough to maintain air seal integrity and traction during the deformation.

As depicted in FIG. 2A, dimension 4 denotes the difference in radii or outside diameters of large diameter tires and that of small diameter tires where twice this amount equals the difference in their diameters in default condition. This is called the H-Factor or H. The effective radius of large diameter tires must decrease by the amount of H in order for the transition between efficiency and performance modes to occur. Thus, the H-Factor is a very important design criterion of the invention. Dimension 5 is the radius of the small diameter tire and is signified by A in the equations below. Dimension 6 is the radius of the large diameter tire and is signified by R in the equations below. Dimension 6A is half the length of the footprint of the large diameter tire while in performance mode and is signified by B in the equations below. Dimension 7P is the length of the footprint of the large diameter tire while in performance mode and is signified by L in the equations below. Dimension 8 is the width of the footprint of the large diameter tire while in efficiency mode and is signified by W in the equations below.

Force analysis reveals that the weight or mass of the vehicle yields an overall force generally in the direction of: downward, downward-forward, downward-rearward, and/or downward-lateral. When the vehicle is at rest, force is downward. When the vehicle changes momentum, as when accelerating, turning, or breaking, overall force is typically in the direction of downward-forward, downward-rearward, and/or downward-lateral. When travelling slowly, or travelling in a relatively straight line, the vehicle should be supported solely by the large diameter tires. In this condition, applying Newton's second law (F=ma), weight (F) of the vehicle with passengers and cargo must equal at least the pressure (P) in the large diameter tires times the area of the collective tire footprints of large diameter tires. In equation form, F must be less than or equal to 4×(P×7E×W). An increase in F or weight in the downward, downward-forward, downward-rearward, and/or downward-lateral in any direction brought on by breaking, turning, acceleration, or other change in momentum, of the vehicle, in turn, causes large diameter tire footprint to increase from the increased weight. This occurs because pressure in the large diameter tire is by in large kept constant. The weight increase (AF) causes flexing of the tire material and increases the footprint area to compensate for AF. The particular amount of increase in this force or effective weight increase required to cause the flexing and bring the small diameter tires in contact with the road surface is of particular importance. When this occurs, F+ΔF must be greater than 4×(P×L×W) in order for small diameter tires to come in contact with the road surface. This point must be carefully set to yield the proper balance between efficiency and safety. The proper H, A, R, L, P, and W of the large diameter tire in relationship to F, ΔF, and the proper small diameter tire properties must be chosen carefully to yield the optimal or best characteristics. Variables can be determined from application of the Pythagorean theorem: (R)²=(A)²+(B)² or where these variables make a right triangle relationship as seen in FIG. 2A. H can then be solved for using the equation H=R−A or R−(R²−(L/2)²)^{1/2}.

For example, in the case of a typical car that weighs about 3,500 pounds with occupants and cargo, a design may be as follows. ΔF's of 20%, 10%, and 5% are investigated. The larger the ΔF, the more the bias of the design towards efficiency and the more difficult it is for the transfer to performance mode. On the other hand, the smaller ΔF, the easier it is for performance more to occur. Experimentation and analysis have determined that a ΔF of about 5% is very safe and allows transition to occur before any type of loss of vehicle control occurs. In other words, when a change in momentum of the vehicle causes an increase in the effective weight of the vehicle by 5% or 175 pounds in the downward, downward-forward, downward-rearward, and/or downward-lateral direction, the large diameter tires will come in contact with the road surface. A ΔF of 20% is considered to be on the borderline of good safe design. Thus at this threshold, effective weight must change by 700 pounds in order to cause the large diameter tires to come in contact with the road surface. A large diameter tire with a 30-inch outside diameter and widths of 2 and 3 inches were investigated because these are typical tall and narrow designs that substantially improve travel efficiency over traditional car tires. A pressure of 40 psi was used because this pressure strikes a good balance between efficiency and performance.

| | ΔF | | | | | |
|---|---|---|---|---|---|---|
| | 20% | 20% | 10% | 10% | 5% | 5% |
| F (pounds) | 3500 | 3500 | 3500 | 3500 | 3500 | 3500 |
| P (psi) | 40 | 40 | 40 | 40 | 40 | 40 |
| W (inches) | 3 | 2 | 3 | 2 | 3 | 2 |
| R (inches) | 15 | 15 | 15 | 15 | 15 | 15 |
| 7E (inches) | 7.29 | 10.94 | 7.29 | 10.94 | 7.29 | 10.94 |
| L (inches) | 8.75 | 13.13 | 8.02 | 12.03 | 7.66 | 11.48 |
| H (inches) | 0.65 | 1.51 | 0.55 | 1.26 | 0.50 | 1.14 |

Equations used for this table are: 7E=F/(4×P×W); L=(ΔF+F)/(4×P×W); and H=R−(R²−(L/2)²)^{1/2}. The number 4 represents the four tires of the vehicle.

Analysis of the above data may yield an optimum design of ΔF=10%, W=3 inches, and H=0.55 inches with P=40 PSI. Thus, the large diameter tire would be 30 inches in outside diameter and 3 inches wide with 40 psi inflation pressure. Small diameter tire would then have diameter of 30 minus 2×0.55 or 28.90 inches. The H-Factor is 0.55 inches. The relationship of variables is nonlinear with multiple unknowns so variation of one variable can dramatically change others, so an iterative mathematical design process must be done with the variation of one variable requiring analysis of the result on the whole system. Additionally, after mathematical design is completed, physical experiments may be done to verify design features regarding performance and safety tradeoffs. The above four factors are the critical factors regarding the operation of transition between modes of the invention. Applicant has determined that the large diameter tire should have a width of about 2-6 inches, diameter of about 20-40 inches, and pressure of about 30-50 psi in order to yield the desired characteristics.

What is claimed is:

1. A multi-diameter tire and wheel assembly comprising:
at least one large diameter tire;
at least one large diameter wheel;
at least one small diameter tire;
at least one small diameter wheel; and
a wheel connection means, wherein,
the number of said wheels is equal to the number of said tires in each said multi-diameter tire and wheel assembly,
each said large diameter tire is mounted and inflated onto one said large diameter wheel and each said small diameter tire is mounted and inflated onto one said small diameter wheel,
said wheels are connected together in adjacent concentric fashion by said wheel connection means so that the centers of each said wheel and each said tire are aligned on the central longitudinal axis running down the center of said multi-diameter tire and wheel assembly,
each said large diameter tire has an overall radius 1-15 percent larger than that of each said small diameter tire, and
each said large diameter tire has an overall width less than that of each said small diameter tire.

2. A multi-diameter tire and wheel assembly as recited in claim 1 wherein said wheel connection means is accomplished by bolts, screws, studs, nuts, lug nuts, clamps, rivets, or welds.

3. A multi-diameter tire and wheel assembly as recited in claim 1 wherein said wheel connection means is accomplished by unibody construction by molding, casting, pouring, or machining process.

4. A multi-diameter tire and wheel assembly as recited in claim 1 further comprising a hub connection means wherein said hub connection means connects said multi-diameter tire and wheel assembly to a hub of a vehicle.

5. A multi-diameter tire and wheel assembly as recited in claim 4 wherein said hub connection means is accomplished by existing threaded studs permanently attached to the vehicle hub where said multi-diameter tire and wheel assembly is sandwiched between the studs and a lug nut securely tightened on the other side of said multi-diameter tire and wheel assembly, thus there is a stud hole pattern on said wheels through which studs are inserted.
